(19) United States
(12) Patent Application Publication
(10) Pub. No.: US 2025/0296341 A1
(43) Pub. Date: Sep. 25, 2025

(54) LIQUID EJECTION APPARATUS AND CONTROL METHOD FOR LIQUID EJECTION APPARATUS

(71) Applicant: SEIKO EPSON CORPORATION, Tokyo (JP)

(72) Inventor: Sawako TSUJIMURA, SHIOJIRI-SHI (JP)

(21) Appl. No.: 19/086,374

(22) Filed: Mar. 21, 2025

(30) Foreign Application Priority Data
Mar. 25, 2024 (JP) 2024-047711

(51) Int. Cl. B41J 2/17; B41J 11/00

(52) U.S. Cl. CPC B41J 2/1707; B41J 11/00214

(57) ABSTRACT

A printing unit that ejects liquid from a plurality of nozzles to perform printing on a medium, an irradiation unit that emits light to cure the ejected liquid, and a control unit are provided, in which the control unit is configured to execute flushing of ejecting the liquid from the plurality of nozzles regardless of the printing and change an empty ejection amount of each of the nozzles in the flushing based on an influence degree of the light emitted from the irradiation unit on each of the nozzles and a print ejection amount of each of the nozzles in the printing.

The present application is based on, and claims priority from JP Application Serial Number 2024-047711, filed Mar. 25, 2024, the disclosure of which is hereby incorporated by reference herein in its entirety.

### BACKGROUND

### 1. Technical Field

The present disclosure relates to a liquid ejection apparatus such as a printer and a method for controlling the liquid ejection apparatus.

### 2. Related Art

For example, as disclosed in JP-A-2014-4701, there is known an image forming apparatus that is an example of a liquid ejection apparatus. The image forming apparatus includes a plurality of head units, each of which is an example of a printing unit, and an irradiation unit.

The head unit ejects ink, which is an example of a liquid, from nozzles to perform recording on a recording medium that is an example of a medium. The ink is cured by the action of an energy ray that is an example of light. The irradiation unit irradiates the recording medium onto which the ink was ejected with energy rays to cure the ink on the recording medium.

If the energy rays leak to the vicinity of a nozzle, the ink before ejection may be cured causing nozzle clogging. Therefore, the image forming apparatus performs maintenance, which is an example of flushing in which ink is ejected from the nozzles. An image reading apparatus makes the ink ejection amount of the head unit closest to the irradiation unit larger than the ink ejection amounts of the other head units.

In some cases, nozzle clogging is likely to occur in a nozzle that is away from the irradiation unit. For example, the ease of curing of the liquid subjected to light may vary depending on the type of liquid. The light irradiated by the irradiation unit may affect a nozzle that is away from the irradiation unit by, for example, being diffused in the medium.

In a case where a nozzle that is likely to be clogged is located at a position away from the irradiation unit, if flushing is performed with the ejection amount of the nozzle close to the irradiation unit increased, the liquid is wastefully consumed.

### SUMMARY

A liquid ejection apparatus that solves the above problem includes a printing unit configured to eject liquid from a plurality of nozzles to perform printing on a medium, an irradiation unit configured to emit light to cure the ejected liquid, and a control unit, wherein the control unit is configured to execute flushing of ejecting the liquid from the plurality of nozzles regardless of the printing and change an empty ejection amount of each of the nozzles in the flushing based on an influence degree of the light emitted from the irradiation unit on each of the nozzles and a print ejection amount of each of the nozzles in the printing.

A method for controlling a liquid ejection apparatus that solves the above problem is a method for controlling a liquid ejection apparatus including a printing unit configured to eject liquid from a plurality of nozzles to perform printing on a medium and an irradiation unit configured to emit light to cure the ejected liquid, the method including calculating an influence degree of the light emitted from the irradiation unit on each of the nozzles, calculating a print ejection amount of each of the nozzles in the printing, and changing an empty ejection amount of each of the nozzles in flushing for ejecting the liquid from the plurality of nozzles regardless of the printing based on the influence degree and the print ejection amount.

### BRIEF DESCRIPTION OF THE DRAWINGS

FIG. 1 is a schematic front view of an embodiment of a liquid ejection apparatus.

FIG. 2 is a schematic plan view of a movement mechanism.

FIG. 3 is a schematic bottom view of a carriage.

FIG. 4 is a flowchart illustrating an empty ejection amount setting routine.

### DESCRIPTION OF EMBODIMENTS

### Embodiments

An embodiment of a liquid ejection apparatus and a method for controlling the liquid ejection apparatus will be described below with reference to the drawings. The liquid ejection apparatus is, for example, an inkjet printer that ejects ink, which is an example of liquid, onto a medium such as paper, fabric, vinyl, a plastic part, or a metal part to perform recording on it.

In the drawings, a Z-axis represents a direction of gravity and an X-axis and a Y-axis represent directions along a horizontal plane, assuming that a liquid ejection apparatus 11 is placed on the horizontal plane. The X-axis, the Y-axis, and the Z-axis are orthogonal to one another.

### Liquid Ejection Apparatus

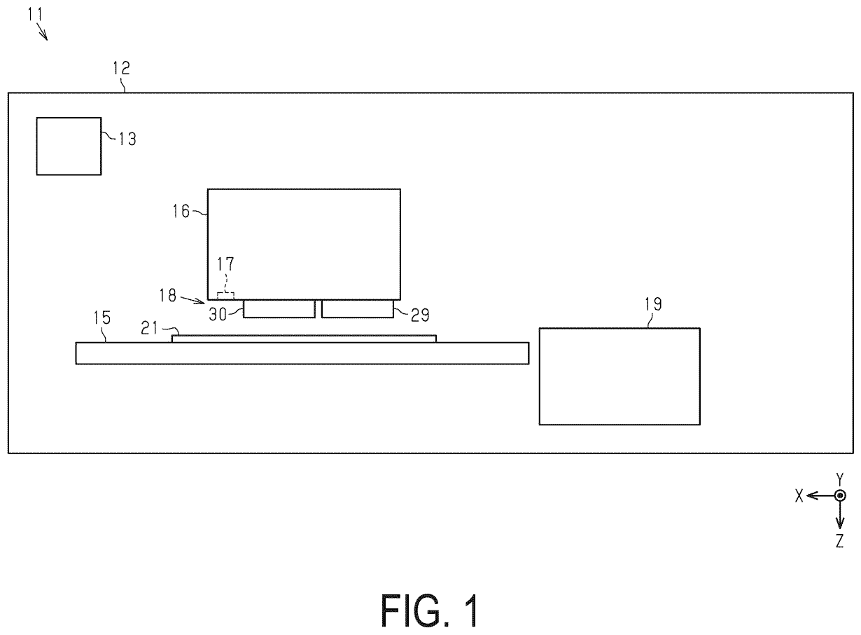

As illustrated in FIG. 1, the liquid ejection apparatus 11 includes a housing 12. The housing 12 houses various components of the liquid ejection apparatus 11.

The liquid ejection apparatus 11 includes a control unit 13. The control unit 13 comprehensively controls driving of each mechanism in the liquid ejection apparatus 11 and controls various operations performed in the liquid ejection apparatus 11.

The control unit 13 can be configured as a circuit including a: one or more processors that execute various processes in accordance with a computer program, B: one or more dedicated hardware circuits that execute at least some of the various processes, or y: a combination thereof. The hardware circuit is, for example, an application specific integrated circuit. The processor includes a CPU and a memory such as a RAM and a ROM, and the memory holds program codes or commands configured to cause the CPU to execute processing. The memory, i.e., a computer readable medium includes any readable mediums that can be accessed by general-purpose or dedicated computers.

The liquid ejection apparatus 11 may include a supporting unit 15, a carriage 16, an irradiation unit 17, a printing unit 18, and a liquid accommodation unit 19.

The supporting unit 15 is configured to support a medium 21.

The carriage 16 may be configured to hold the irradiation unit 17 and the printing unit 18 in a movable manner. The irradiation unit 17 and the printing unit 18 may be mounted on the carriage 16.

The irradiation unit 17 emits light to cure the ejected liquid. For example, in a case where the liquid is UV ink, the irradiation unit 17 emits ultraviolet light. The irradiation unit 17 cures the liquid ejected onto the medium 21 to fix the liquid onto the medium 21.

The liquid contains a component that is cured by the light emitted by the irradiation unit 17. For example, the liquid contains a photopolymerization initiator that initiates polymerization by ultraviolet energy. As the photopolymerization initiator, for example, a photoradical polymerization initiator or a photocationic polymerization initiator can be used.

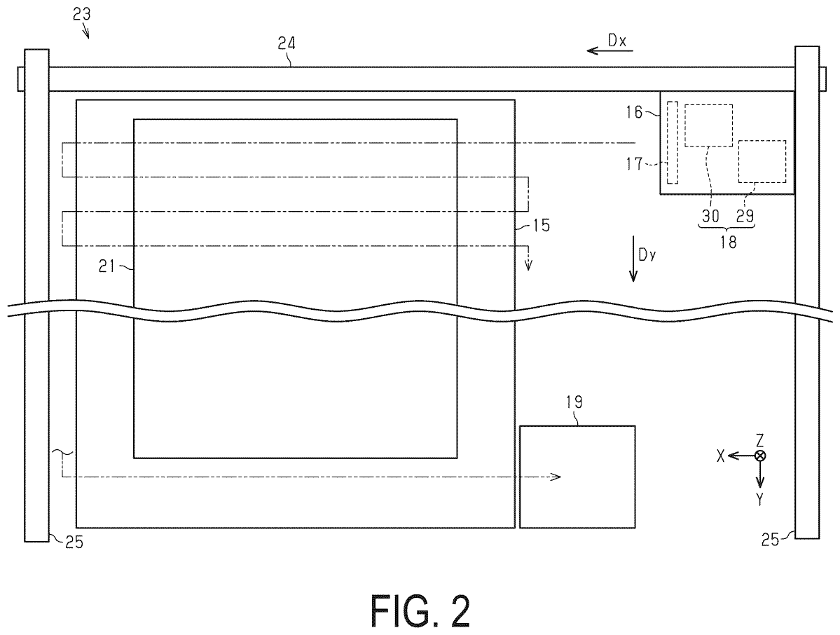

As illustrated in FIG. 2, the liquid ejection apparatus 11 may include a movement mechanism 23. The movement mechanism 23 may include a horizontal shaft 24 and a vertical shaft 25. The movement mechanism 23 of the present embodiment includes a pair of vertical shafts 25.

The horizontal shaft 24 may extend in a scanning direction Dx. The pair of vertical shafts 25 may be provided in parallel to each other so as to extend in a sub-scanning direction Dy. The scanning direction Dx in the present embodiment is a direction parallel to the X-axis. The sub-scanning direction Dy in the present embodiment is a direction perpendicular to the X-axis and parallel to the Y-axis.

The movement mechanism 23 causes the carriage 16 to reciprocate along the horizontal shaft 24. The carriage 16 is configured to move the printing unit 18 in the scanning direction Dx. The movement mechanism 23 causes the horizontal shaft 24 supporting the carriage 16 to reciprocate along the vertical shafts 25. Therefore, the movement mechanism 23 can move the irradiation unit 17 and the printing unit 18 mounted on the carriage 16 in the scanning direction Dx and the sub-scanning direction Dy.

The movement mechanism 23 may simultaneously move the printing unit 18 in the scanning direction Dx and the sub-scanning direction Dy. That is, the movement mechanism 23 may move the printing unit 18 obliquely with respect to the scanning direction Dx and the sub-scanning direction Dy to lie along the horizontal plane.

In the liquid ejection apparatus 11, the carriage 16 is scanned with respect to the medium 21. The printing unit 18 prints an image on the medium 21 by ejecting liquid while scanning together with the carriage 16. The carriage 16 in the present embodiment is configured to scan the medium 21 and to also move in the sub-scanning direction Dy intersecting the scanning direction Dx in which the scanning is performed. That is, the liquid ejection apparatus 11 of the present embodiment is a so-called lateral printer.

### Printing Unit

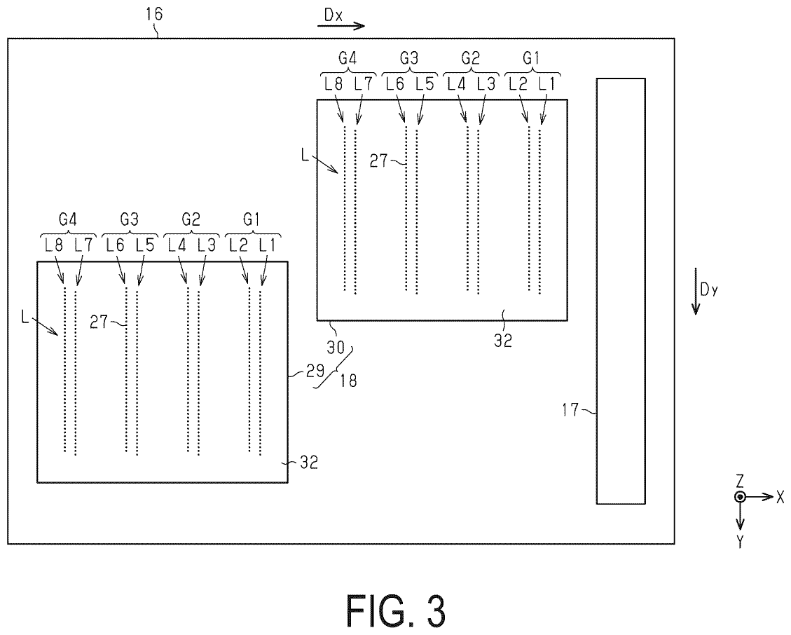

As illustrated in FIG. 3, the printing unit 18 performs printing on the medium 21 by ejecting liquid from a plurality of nozzles 27. The printing unit 18 may include a first ejection unit 29 and a second ejection unit 30.

The first ejection unit 29, the second ejection unit 30, and the irradiation unit 17 may be provided side by side in the scanning direction Dx. The first ejection unit 29, the second ejection unit 30, and the irradiation unit 17 may be provided at different positions in the scanning direction Dx with an interval therebetween in the scanning direction Dx. The first ejection unit 29 and the second ejection unit 30 may be provided at different positions in the sub-scanning direction Dy so as to partially overlap each other in the sub-scanning direction Dy. The second ejection unit 30 may be located downstream of the first ejection unit 29 in the scanning direction Dx and upstream in the sub-scanning direction Dy. In the sub-scanning direction Dy, the printing unit 18 may be smaller than the irradiation unit 17.

The first ejection unit 29 and the second ejection unit 30 of the present embodiment have the same configuration. Therefore, in the following description, the first ejection unit 29 will be described, and the same reference numerals are given to common configurations, and redundant description will be omitted.

The first ejection unit 29 is configured to eject liquid. The first ejection unit 29 includes the plurality of nozzles 27. Each of the nozzles 27 is configured to eject liquid. The first ejection unit 29 ejects liquid while moving with respect to the medium 21 supported by the supporting unit 15 to print an image on the medium 21.

The first ejection unit 29 has a nozzle surface 32. A plurality of nozzle rows L are formed at the nozzle surface 32 by the plurality of nozzles 27. A first nozzle row L1 to an eighth nozzle row L8 are formed at the nozzle surface 32 of the present embodiment. One nozzle row L is formed by the plurality of nozzles 27 arranged side by side in the sub-scanning direction Dy. The sub-scanning direction Dy in which the plurality of nozzles 27 forming the nozzle row L are arranged may be parallel to the longitudinal direction of the irradiation unit 17.

The plurality of nozzle rows L are extended in the sub-scanning direction Dy and are formed at predetermined intervals in the scanning direction Dx. The plurality of nozzle rows L may be formed at equal intervals in the scanning direction Dx or may be formed at different intervals. For example, in the first nozzle row L1 to the eighth nozzle row L8, some of the nozzle rows L may be arranged side by side to be close to each other in the scanning direction Dx. In the present embodiment, two nozzle rows L arranged side by side to be close to each other are referred to as a nozzle group.

The first ejection unit 29 includes a first nozzle group G1 to a fourth nozzle group G4. The first nozzle group G1 includes a first nozzle row L1 and a second nozzle row L2. The second nozzle group G2 includes a third nozzle row L3 and a fourth nozzle row L4. The third nozzle group G3 includes a fifth nozzle row L5 and a sixth nozzle row L6. The fourth nozzle group G4 includes a seventh nozzle row L7 and an eighth nozzle row L8. The first nozzle group G1 to the fourth nozzle group G4 may be arranged side by side at equal intervals in the scanning direction Dx.

The printing unit 18 may eject the same type of liquid from all the nozzles 27. The printing unit 18 may eject the same type of liquid in any unit, for example, for each ejection unit, for each nozzle group, or for each nozzle row L.

The printing unit 18 may eject a plurality of types of liquids. The different types of liquid are, for example, inks of different colors. For example, the first ejection unit 29 may eject color inks such as magenta, yellow, cyan, black, light cyan, light magenta, gray, and red from the first nozzle row L1 to the eighth nozzle row L8, respectively. The first nozzle row L1 to the eighth nozzle row L8 of the first ejection unit 29 may eject color inks of different colors. For example, the second ejection unit 30 may eject transparent ink from the first nozzle row L1 to the fourth nozzle row L4, and may eject white ink from the fifth nozzle row L5 to the eighth nozzle row L8.

### Liquid Accommodation Unit

As illustrated in FIG. 2, the liquid accommodation unit 19 may be provided, for example, at a position adjacent, in the scanning direction Dx, to the downstream end of the supporting unit 15 in the sub-scanning direction Dy. The liquid accommodation unit 19 is configured to collect the liquid discharged from the printing unit 18 as a waste liquid. The waste liquid is liquid that does not contribute to an image recorded on the medium 21.

The control unit 13 is configured to execute flushing of causing liquid to be ejected from the plurality of nozzles 27 regardless of printing. The flushing is an operation of ejecting liquid from the nozzles 27 in order to suppress clogging of the nozzles 27. The flushing may be executed for each nozzle row L or for every plurality of nozzle rows L, or may be executed collectively for all of the nozzle rows L. When flushing is executed, the printing unit 18 ejects liquid toward the liquid accommodation unit 19.

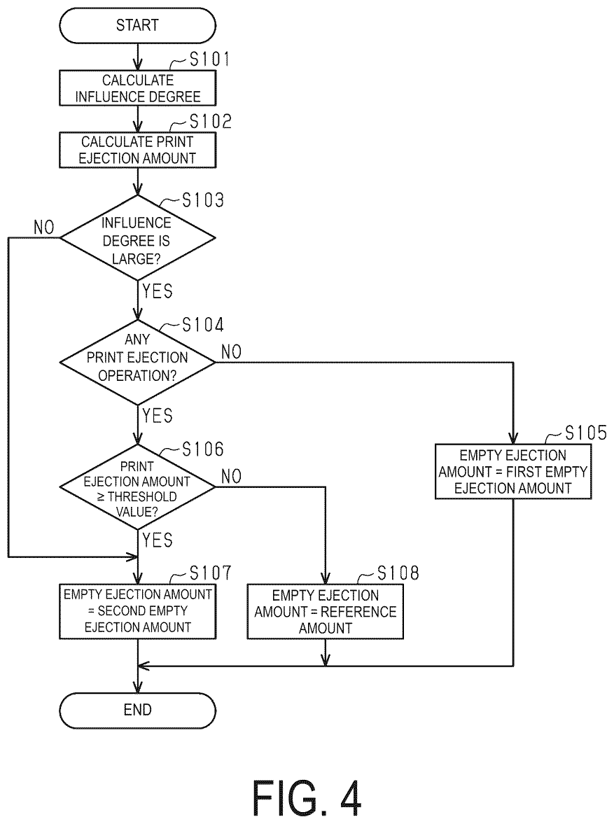

Empty ejection amount setting routine Next, a method for controlling the liquid ejection apparatus 11 will be described with reference to a flowchart shown in FIG. 4. An empty ejection amount setting routine illustrated in FIG. 4 is executed, for example, at a timing when print data is acquired.

The control unit 13 may change the empty ejection amount of each nozzle 27 in flushing by repeatedly executing the empty ejection amount setting routine. The control unit 13 may set the empty ejection amount of each nozzle 27 by executing the empty ejection amount setting routine for each of the plurality of nozzles 27.

As illustrated in FIG. 4, in step S101, the control unit 13 calculates the influence degree of the light emitted from the irradiation unit 17 on each nozzle 27. The control unit 13 may calculate the influence degree using the distance from each nozzle 27 to the irradiation unit 17. The control unit 13 may calculate the influence degree using the ease of curing of the liquid. The control unit 13 may calculate the influence degree using at least one of the distance to the irradiation unit 17 and the ease of curing of the liquid.

For example, the transparent ink may use an ink that is more easily cured than the colored ink. The first nozzle row L1 to the fourth nozzle row L4 of the second ejection unit 30 that ejects the transparent ink are located at positions closer to the irradiation unit 17 than the other nozzle rows L. In this case, the influence degree of the second ejection unit 30 on each of the nozzles 27 forming the first nozzle row L1 to the fourth nozzle row L4 is greater than the influence degree on each of the nozzles 27 forming the other nozzle rows L.

In step S102, the control unit 13 calculates the print ejection amount of each nozzle 27 in printing. The control unit 13 may calculate the print ejection amount using the number of liquid droplets ejected from each nozzle 27. The control unit 13 may calculate the print ejection amount using the amount per one droplet of the liquid droplets ejected from each nozzle 27. For example, when the amount of liquid droplets per droplet is constant, the control unit 13 may set the number of liquid droplets to be ejected as the print ejection amount.

In step S103, the control unit 13 executes a first determination. As the first determination, the control unit 13 determines the magnitude of the influence degree for the nozzle 27 for which the empty ejection amount is set. For example, the control unit 13 may compare the influence degree calculated in step S101 with a reference degree. When the influence degree is the reference degree or more, YES is determined in step S103, and the control unit 13 proceeds the process to step S104.

In step S104, the control unit 13 executes a second determination. As the second determination, the control unit 13 determines whether to execute the ejection operation in printing for the first nozzle determined to have a large influence degree in the first determination. That is, when the print ejection amount calculated in step S102 is zero, the control unit 13 determines that there is no print ejection operation. When the print ejection amount calculated in step S102 is not zero, the control unit 13 determines that there is print ejection operation.

When determined in step S104 that there is no print ejection operation, NO is determined in step S104, and the control unit 13 proceeds the process to step S105. In step S105, the control unit 13 sets the empty ejection amount to a first empty ejection amount. That is, the control unit 13 sets the empty ejection amount of the second nozzle, for which determination is made not to execute the print ejection operation in the second determination, to the first empty ejection amount. The first empty ejection amount is an amount larger than a reference amount.

When determined in step S104 that there is print ejection operation, YES is determined in step S104, and the control unit 13 proceeds the process to step S106. In step S106, the control unit 13 executes a third determination. As a third determination, the control unit 13 compares the print ejection amount with a threshold value for the third nozzle determined to execute the print ejection operation.

When determined that the print ejection amount is the threshold value or more, YES is determined in step S106, and the control unit 13 proceeds the process to step S107. In step S107, the control unit 13 sets the empty ejection amount to a second empty ejection amount. That is, the control unit 13 sets the empty ejection amount of the fourth nozzle, for which determination is made that the print ejection amount is the threshold value or more in the third determination, to the second empty ejection amount. The second ejection amount is less than the reference amount.

When determined that the print ejection amount is less than the threshold value, NO is determined in step S106, and the control unit 13 proceeds the process to step S108. In step S108, the control unit 13 sets the empty ejection amount to the reference amount. That is, the control unit 13 sets the empty ejection amount of the fifth nozzle, for which determination is made that the print ejection amount is less than the threshold value in the third determination, as the reference amount.

When the influence degree is smaller than the reference degree in step S103, NO is determined in step S103, and the control unit 13 proceeds the process to step S107. That is, the control unit 13 sets the empty ejection amount of the sixth nozzle, for which determination is made that the influence degree is small in the first determination, to the second empty ejection amount.

### Operation of Present Embodiment

Operations of the present embodiment will be described. The control unit 13 changes the empty ejection amount of each nozzle 27 in flushing based on the influence degree and the print ejection amount. For each nozzle 27, the control unit 13 may start printing after the setting of the empty ejection amount is completed, may set the empty ejection amount while printing, or may set the empty ejection amount after printing.

The carriage 16 illustrated in FIG. 2 is located at a home position. When printing is not performed, the carriage 16 waits at the home position. The home position may be located at the upstream end in the sub-scanning direction Dy in the region where the carriage 16 is movable.

When printing is performed, the control unit 13 moves the carriage 16 as indicated by a two-dot chain line arrow in FIG. 2. That is, the carriage 16 repeatedly performs movement in the scanning direction Dx, the sub-scanning direction Dy, the direction opposite to the scanning direction Dx, and the sub-scanning direction Dy, thereby moving to the downstream end in the sub-scanning direction Dy of the region where the carriage 16 is movable.

The movement of the carriage 16 in the scanning direction Dx or the direction opposite to the scanning direction Dx performed between the movements in the sub-scanning direction Dy is also referred to as a pass movement. The movement of the carriage 16 from the upstream end to the downstream end in the sub-scanning direction Dy is also referred to as layer movement.

The printing unit 18 may perform printing by ejecting liquid to form a plurality of layers on the medium 21. The control unit 13 may form a plurality of layers on the medium 21 by executing the layer movement over a plurality of times. The control unit 13 of the present embodiment performs printing by executing layer movement three times with respect to one medium 21.

Printing involved in the first layer movement is also referred to as first printing. In the first printing, the control unit 13 causes the printing unit 18 to eject, for example, white ink and causes the irradiation unit 17 to emit light. According to the first printing, a first layer in which the white ink is cured is formed on the medium 21. After the first printing is finished, the control unit 13 moves the carriage 16 in a direction opposite to the sub-scanning direction Dy and returns the carriage 16 to the upstream end in the sub-scanning direction Dy.

Printing involved in the second layer movement is also referred to as second printing. In the second printing, the control unit 13 causes the printing unit 18 to eject, for example, color ink, and causes the irradiation unit 17 to emit light. According to the second printing, a second layer in which the color ink is cured is formed on the first layer. After the second printing is finished, the control unit 13 moves the carriage 16 in a direction opposite to the sub-scanning direction Dy and returns the carriage 16 to the upstream end in the sub-scanning direction Dy.

Printing involved in the third layer movement is also referred to as third printing. In the third printing, the control unit 13 causes the printing unit 18 to eject, for example, the transparent ink, and causes the irradiation unit 17 to emit light. According to the third printing, a third layer in which the transparent ink is cured is formed on the second layer.

The control unit 13 may execute flushing after printing is finished. The control unit 13 may execute the flushing after the first, second, and third printing are finished. In a state in which the printing unit 18 faces the liquid accommodation unit 19, the control unit 13 causes liquid of the set empty ejection amount to be ejected from each nozzle 27. After the flushing is finished, the control unit 13 moves the carriage 16 to the home position.

### Effects of Embodiment

Effects of the present embodiment will be described.

(1-1) The control unit 13 changes the empty ejection amount of each nozzle 27 based on the influence degree of light and the print ejection amount. For example, the nozzle 27 having a large print ejection amount ejects the affected liquid in printing even if the influence degree of light is large. That is, in the nozzle 27 having a large print ejection amount, liquid affected by light is less likely to remain after printing. Therefore, the amount of liquid consumed by flushing can be reduced by performing flushing in consideration of the influence degree of light and the print ejection amount.

(1-2) The control unit 13 sets the empty ejection amount of the second nozzle that has a large influence degree of light and does not execute the ejection operation in printing to the first empty ejection amount larger than the reference amount. Therefore, liquid greatly affected by light can be discharged by flushing, and the risk of occurrence of ejection failure can be reduced.

(1-3) The control unit 13 sets the empty ejection amount of the fourth nozzle having a large print ejection amount to be smaller than the empty ejection amount of the fifth nozzle having a small print ejection amount. The amount of liquid consumed by flushing can be reduced while reducing the risk of occurrence of ejection failure by reducing the empty ejection amount of the fourth nozzle in which the liquid affected by light is less likely to remain.

(1-4) The control unit 13 sets the empty ejection amount of the sixth nozzle having a small influence degree of light to the second empty ejection amount smaller than the reference amount. Therefore, the amount of liquid consumed by flushing can be reduced. (1-5) The influence degree is calculated using the distance from each nozzle 27 to the irradiation unit 17. For example, light leaking from irradiation unit 17 is likely to directly affect the nozzle 27 close to irradiation unit 17. Therefore, the influence degree can be easily calculated by using the distance from the nozzle 27 to the irradiation unit 17.

(1-6) The influence degree is calculated using the ease of curing of the liquid ejected from the nozzle 27. A liquid that is easily cured is greatly affected even with a small amount of light. The accuracy of the influence degree can be improved by using the ease of curing of the liquid.

(1-7) The control unit 13 executes flushing after the printing is finished. Therefore, the liquid affected by light accompanying the printing can be discharged by executing flushing.

### Modified Example

The embodiments may be modified as follows for implementation. The embodiments and modified examples described below may be combined for implementation insofar as they are not technically inconsistent.
The control unit 13 may execute the setting of the empty ejection amount over a plurality of times.

For example, the control unit 13 may set the first empty ejection amount based on the print ejection amount accompanying the first printing, and then perform the first printing. Subsequently, the control unit 13 may set the second empty ejection amount based on the print ejection amount accompanying the second printing, and then perform the second printing.

For example, after performing the first printing, the control unit 13 may set the first empty ejection amount based on the print ejection amount accompanying the first printing. Subsequently, after performing the second printing, the control unit 13 may set the second empty ejection amount based on the print ejection amount accompanying the second printing.

The control unit 13 may execute flushing after performing printing for a plurality of times. The empty ejection amount to be ejected from each nozzle 27 by flushing may be the sum of the first empty ejection amount, the second empty ejection amount, and the like set in a plurality of times, or may be the larger one.
The control unit 13 may execute flushing when one layer is formed. The control unit 13 may execute the flushing between one printing. The control unit 13 executes flushing when one layer is formed. Therefore, the liquid affected by light accompanying the formation of the layer can be discharged by executing flushing.

The control unit 13 may execute the first flushing after the first printing is finished. The control unit 13 may execute the second flushing after the second printing is finished. The empty ejection amount of each nozzle 27 in the first flushing may be set based on the print ejection amount accompanying the first printing. The empty ejection amount of each nozzle 27 in the second flushing may be set based on the print ejection amount accompanying the second printing.

The control unit 13 may collectively set each empty ejection amount in the flushing of a plurality of times before printing.

The control unit 13 may set the empty ejection amount based on the print ejection amount accompanying the next printing before performing one printing. The control unit 13 may execute the first printing and the first flushing after setting the empty ejection amount of the first flushing. The control unit 13 may execute the second printing and the second flushing after setting the empty ejection amount of the second flushing.

The control unit 13 may set the empty ejection amount based on the print ejection amount accompanying the immediately preceding printing after performing one printing. The control unit 13 may set the empty ejection amount of the first flushing before executing the first flushing after the first printing is finished. The control unit 13 may set the empty ejection amount of the second flushing before executing the second flushing after the second printing is finished.
The liquid ejection apparatus 11 may include a plurality of liquid accommodation units 19. The liquid accommodation unit 19 may be provided on both sides of the supporting unit 15 in the scanning direction Dx. Each liquid accommodation unit 19 may be provided over the sub-scanning direction Dy.

The control unit 13 may execute flushing after moving the carriage 16 in the scanning direction Dx. The control unit 13 may execute flushing between pass movements. The control unit 13 moves the printing unit 18 in the scanning direction Dx together with the carriage 16, and then executes flushing. Therefore, the liquid affected by light while moving in the scanning direction Dx can be discharged by executing flushing.

The printing unit 18 may perform one printing by one pass movement. The control unit 13 may alternately execute one printing and one flushing. The empty ejection amount of each nozzle 27 in flushing may be set based on the print ejection amount accompanying one printing before flushing.

The control unit 13 may collectively set each empty ejection amount in the flushing of a plurality of times before printing.

The control unit 13 may set the empty ejection amount based on the print ejection amount accompanying the next printing before performing one printing. The control unit 13 may execute the first printing and the first flushing after setting the empty ejection amount of the first flushing. The control unit 13 may execute the second printing and the second flushing after setting the empty ejection amount of the second flushing.

The control unit 13 may set the empty ejection amount based on the print ejection amount accompanying the immediately preceding printing after performing one printing. The control unit 13 may set the empty ejection amount of the first flushing before executing the first flushing after the first printing is finished. The control unit 13 may set the empty ejection amount of the second flushing before executing the second flushing after the second printing is finished.
The control unit 13 may execute flushing at the timing when the carriage 16 reciprocates in the scanning direction Dx. The empty ejection amount of each nozzle 27 in the flushing may be set based on the print ejection amount ejected from each nozzle 27 to the medium 21 in the reciprocating movement before the flushing.
The influence degree of the light emitted from the irradiation unit 17 on each nozzle 27 may be calculated in advance and stored in, for example, a storage unit (not illustrated). The influence degree may be set in consideration of the influence of light reflected by the medium 21 or the like. The influence degree may be stored in association with the type of the medium 21. The influence degree may be set such that the influence degree of the nozzle 27 that is easily clogged is large and the influence degree of the nozzle 27 that is not easily clogged is small based on the experimental result of printing on the medium 21. The control unit 13 may acquire the influence degree stored in the storage unit in step S101 illustrated in FIG. 4.
The control unit 13 may collectively calculate the influence degree on some nozzles 27 among the plurality of nozzles 27. Specifically, the control unit 13 may calculate the influence degree on each nozzle 27 for each nozzle row L. That is, the influence degree on each nozzle 27 constituting one nozzle row L may be the same. Similarly, the control unit 13 may calculate the degree of influence degree on each nozzle 27 for each nozzle group. The control unit 13 may calculate the influence degree on each nozzle 27 for each ejection unit. The control unit 13 may calculate the influence degree on each nozzle 27 for each nozzle 27 that ejects the same type of liquid.
The liquid ejection apparatus 11 may store the influence degree by the light emitted from the irradiation unit 17, the print ejection amount, and the empty ejection amount in association with each other. The empty ejection amount may be stored as a matrix indicated by the influence degree and the empty ejection amount. The control unit 13 may acquire the stored empty ejection amount based on the influence degree and the empty ejection amount.
The printing unit 18 may not include the second ejection unit 30. The printing unit 18 may complete printing by forming one layer on the medium 21.
The control unit 13 may not execute at least one of the first determination, the second determination, and the third determination.
The irradiation unit 17 may be provided separately from the carriage 16. The liquid ejection apparatus 11 may include a first carriage that moves the printing unit 18 and a second carriage that moves the irradiation unit 17. The irradiation unit 17 may be fixed.
The second empty ejection amount may be zero. That is, the fourth nozzle having a large influence degree by light on the nozzle 27 and a print ejection amount of the threshold value or more may not eject liquid when performing flushing of other nozzles 27. The sixth nozzle having a small influence degree by light on the nozzle 27 may not eject liquid when performing flushing of other nozzles 27.
The liquid ejection apparatus 11 may be a serial printer, a lateral printer, a line printer, a page printer, or the like.
The liquid ejection apparatus 11 may be a liquid ejection apparatus that sprays or ejects other liquid other than ink. The state of the liquid ejected from the liquid ejection apparatus in a form of minute amount of liquid droplets is assumed to include a particulate form, a teardrop form, and a thread like extending form. The liquid referred to herein may be any material that can be ejected from the liquid ejection apparatus. For example, the liquid merely needs to be in a state when the substance is in a liquid phase, and includes a liquid body having high or low viscosity, a sol, gel water, other inorganic solvents, an organic solvent, a solution, a liquid resin, a liquid metal, a metal melt, or the like. The liquid includes not only a liquid serving as one state of a substance but also particles of a functional material made of a solid such as a pigment or metal particles dissolved, dispersed, or mixed in a solvent. Typical examples of the liquid include ink and liquid crystal as described in the above embodiment. The ink here includes general aqueous ink and oil based ink, and various liquid compositions such as gel ink, and hot melt ink. Specific examples of the liquid ejection apparatus include, for example, an apparatus that ejects a liquid containing a material such as an electrode material or a coloring material used for manufacturing a liquid crystal display, an electroluminescence display, a surface emitting display, or a color filter in a dispersed or dissolved state. The liquid ejection apparatus may be an apparatus that ejects bioorganic substances used for biochip manufacturing, an apparatus that is used as a precision pipette and that ejects liquid to be a sample, a textile printing apparatus, a micro dispenser, or the like. The liquid ejection apparatus may be an apparatus that ejects lubricating oil to a precision machine such as a clock or a camera in a pinpoint manner, or an apparatus that ejects a transparent resin liquid such as ultraviolet curable resin or the like on a substrate for forming a minute hemispherical lens, optical lens, or the like used for an optical communication element and the like. The liquid ejection apparatus may be an apparatus that ejects etching liquid such as an acid or an alkali for etching a substrate or the like.

### Definition

The expression “at least one” as used herein means “one or more” of the desired options. As an example, the expression “at least one” as used herein means “only one option” or “both of two options” if the number of options is two. As another example, the expression “at least one” as used herein means “only one option”, “any combination of two options”, or “any combination of three or more options” when the number of options is three or more.

### Supplementary Note

The following is a description of the technical ideas and their effects that can be grasped from the above-described embodiments and modified examples.

(A) A liquid ejection apparatus including: a printing unit is configured to eject liquid from a plurality of nozzles to perform printing on a medium, an irradiation unit configured to emit light to cure the ejected liquid, and a control unit, wherein the control unit configured to execute flushing of ejecting the liquid from the plurality of nozzles regardless of the printing and change an empty ejection amount of each of the nozzles in the flushing based on an influence degree of the light emitted from the irradiation unit on each of the nozzles and a print ejection amount of each of the nozzles in the printing.

According to this configuration, the control unit changes the empty ejection amount of each nozzle based on the influence degree of light and the print ejection amount. For example, the nozzle having a large print ejection amount ejects the affected liquid in printing even if the influence degree of light is large. That is, in the nozzle having a large print ejection amount, liquid affected by light is less likely to remain after printing. Therefore, the amount of liquid consumed by flushing can be reduced by performing flushing in consideration of the influence degree of light and the print ejection amount.

(B) In the liquid ejection apparatus according to (A), the control unit may execute a first determination of determining the influence degree for each of the nozzles, execute a second determination of determining whether to execute an ejection operation in the printing for a first nozzle determined to have a large influence degree in the first determination, and set an empty ejection amount of a second nozzle determined not to execute the ejection operation in the second determination to a first empty ejection amount larger than a reference amount.

According to this configuration, the control unit sets the empty ejection amount of the second nozzle having a large influence degree of light and not executing the ejection operation in printing to the first empty ejection amount larger than the reference amount. Therefore, liquid greatly affected by light can be discharged by flushing, and the risk of occurrence of ejection failure can be reduced.

(C) In the liquid ejection apparatus according to (B), the control unit may execute a third determination of comparing the print ejection amount with a threshold value for a third nozzle determined to execute the ejection operation in the second determination, set the empty ejection amount of a fourth nozzle determined to have the print ejection amount of the threshold value or more in the third determination to a second empty ejection amount smaller than the reference amount, and set the empty ejection amount of a fifth nozzle determined to have the print ejection amount of less than the threshold value in the third determination to the reference amount.

According to this configuration, the control unit sets the empty ejection amount of the fourth nozzle having a large print ejection amount to be smaller than the empty ejection amount of the fifth nozzle having a small print ejection amount. The amount of liquid consumed by flushing can be reduced while reducing the risk of occurrence of ejection failure by reducing the empty ejection amount of the fourth nozzle in which the liquid affected by light is less likely to remain.

(D) In the liquid ejection apparatus according to any one of (A) to (C), the control unit may execute a first determination of determining the influence degree for each of the nozzles, and set the empty ejection amount of a sixth nozzle determined to have a small influence degree in the first determination to a second empty ejection amount smaller than a reference amount.

According to this configuration, the control unit sets the empty ejection amount of the sixth nozzle having a small influence degree of light to the second empty ejection amount smaller than the reference amount. Therefore, the amount of liquid consumed by flushing can be reduced.

(E) In the liquid ejection apparatus according to (A) to (D), the influence degree may be calculated using a distance from each of the nozzles to the irradiation unit.

According to this configuration, the influence degree is calculated using the distance from each nozzle to the irradiation unit. For example, light leaking from the irradiation unit is likely to directly affect the nozzle close to the irradiation unit. Therefore, the influence degree can be easily calculated by using the distance from the nozzle to the irradiation unit.

(F) In the liquid ejection apparatus according to (A) to (E), the influence degree may be calculated using ease of curing of the liquid.

According to this configuration, the influence degree is calculated using the ease of curing of the liquid ejected from the nozzle. A liquid that is easily cured is greatly affected even with a small amount of light. The accuracy of the influence degree can be improved by using the ease of curing of the liquid.

(G) In the liquid ejection apparatus according to (A) to (F), the control unit may execute the flushing after the printing is finished.

According to this configuration, the control unit executes the flushing after the printing is finished. Therefore, the liquid affected by light accompanying the printing can be discharged by executing flushing.

(H) In the liquid ejection apparatus according to (A) to (F), the printing unit may perform the printing by ejecting the liquid to form a plurality of layers on the medium, and the control unit may execute the flushing when one of the layers is formed.

According to this configuration, the control unit executes flushing when one layer is formed. Therefore, the liquid affected by light accompanying the formation of the layer can be discharged by executing flushing.

(I) The liquid ejection apparatus according to (A) to (F) may further include a carriage configured to move the printing unit in a scanning direction, and the control unit may execute the flushing after moving the carriage in the scanning direction.

According to this configuration, the control unit executes the flushing after moving the printing unit in the scanning direction together with the carriage. Therefore, the liquid affected by light while moving in the scanning direction can be discharged by executing flushing.

(J) A method for controlling a liquid ejection apparatus is a method for controlling a liquid ejection apparatus including a printing unit configured to eject liquid from a plurality of nozzles to perform printing on a medium and an irradiation unit configured to emit light to cure the ejected liquid, the method including: calculating an influence degree of the light emitted from the irradiation unit on each of the nozzles, calculating a print ejection amount of each of the nozzles in the printing, and changing an empty ejection amount of each of the nozzles in flushing for ejecting the liquid from the plurality of nozzles regardless of the printing based on the influence degree and the print ejection amount.

According to this method, effects similar to those of the liquid ejection apparatus described above can be achieved.

What is claimed is:

1. A liquid ejection apparatus comprising:
a printing unit configured to eject liquid from a plurality of nozzles to perform printing on a medium;
an irradiation unit configured to emit light to cure the ejected liquid; and
a control unit; wherein
the control unit is configured to
execute flushing of ejecting the liquid from the plurality of nozzles regardless of the printing and
change an empty ejection amount of each of the nozzles in the flushing based on an influence degree of the light emitted from the irradiation unit on each of the nozzles and a print ejection amount of each of the nozzles in the printing.

2. The liquid ejection apparatus according to claim 1, wherein
the control unit is configured to
execute a first determination of determining the influence degree for each of the nozzles,
execute a second determination of determining whether to execute an ejection operation in the printing for a first nozzle determined to have a large influence degree in the first determination, and
set an empty ejection amount of a second nozzle determined not to execute the ejection operation in the second determination to a first empty ejection amount larger than a reference amount.

3. The liquid ejection apparatus according to claim 2, wherein
the control unit is configured to
execute a third determination of comparing the print ejection amount with a threshold value for a third nozzle determined to execute the ejection operation in the second determination,
set the empty ejection amount of a fourth nozzle determined to have the print ejection amount of the threshold value or more in the third determination to a second empty ejection amount smaller than the reference amount, and
set the empty ejection amount of a fifth nozzle determined to have the print ejection amount of less than the threshold value in the third determination to the reference amount.

4. The liquid ejection apparatus according to claim 1, wherein
the control unit is configured to
execute a first determination of determining the influence degree for each of the nozzles, and
set the empty ejection amount of a sixth nozzle determined to have a small influence degree in the first determination to a second empty ejection amount smaller than a reference amount.

5. The liquid ejection apparatus according to claim 1, wherein the influence degree includes a distance from each of the nozzles to the irradiation unit.

6. The liquid ejection apparatus according to claim 5, wherein the influence degree includes ease of curing of the liquid.

7. The liquid ejection apparatus according to claim 1, wherein the control unit executes the flushing after the printing is finished.

8. The liquid ejection apparatus according to claim 1, wherein
the printing unit performs the printing by ejecting the liquid to form a plurality of layers on the medium, and
the control unit executes the flushing when one of the layers is formed.

9. The liquid ejection apparatus according to claim 1, further comprising:
a carriage configured to move the printing unit in a scanning direction; wherein
the control unit executes the flushing after moving the carriage in the scanning direction.

10. A method for controlling a liquid ejection apparatus, the liquid ejection apparatus including a printing unit configured to eject liquid from a plurality of nozzles to perform printing on a medium and an irradiation unit configured to emit light to cure the ejected liquid, the method comprising:
calculating an influence degree of the light emitted from the irradiation unit on each of the nozzles;
calculating a print ejection amount of each of the nozzles in the printing; and
changing an empty ejection amount of each of the nozzles in flushing for ejecting the liquid from the plurality of nozzles regardless of the printing based on the influence degree and the print ejection amount.
